(19) United States
(12) Patent Application Publication
(10) Pub. No.: US 2012/0232446 A1
(43) Pub. Date: Sep. 13, 2012

(54) Apparatus for Treating Foot Disorders

(76) Inventor: Roy S. Ormsbee D.C., DABCO, Romeo, MI (US)

(21) Appl. No.: 13/344,027

(22) Filed: Jan. 5, 2012

Related U.S. Application Data
(63) Continuation-in-part of application No. 13/042,715, filed on Mar. 8, 2011.

(51) Int. Cl. A61H 7/00

(52) U.S. Cl. 601/134

(57) ABSTRACT

Foot disorders such as Morton's neuroma, plantar fasciitis, heel spurs tarsalgia and metatarsalgia may be treated with the improved apparatus described herein. The apparatus is comprised of a base, a removable stem and at least one therapeutic member. The base rests upon a floor. The stem perpendicularly extends from the base in one direction. A ridge network perpendicularly extends from the base in the other direction to enhance the adhesion of the base to the floor. The therapeutic member is integrally attached to the stem. The therapeutic member has a rigid flat upper surface distal to the base and is sized to be covered by the plantar surface of a foot. To use the apparatus, a user rests the plantar surface of his or her foot on the therapeutic member and moves the foot to stretch foot tissue or to spread metatarsal bones within the foot.

### CROSS-REFERENCE TO RELATED APPLICATION

This is a continuation-in-part of U.S. patent application Ser. No. 13/042,715 filed on Mar. 8, 2011, now pending. Application Ser. No. 13/042,715 is incorporated herein by reference.

### BACKGROUND

Foot disorders are very common. These disorders include plantar fasciitis, Morton's neuroma, heel spurs, tarsalgia and metatarsalgia. Plantar fasciitis is a painful condition involving tightening and/or inflammation of the plantar fascia of the foot. Morton's neuroma involves an excess growth on nerve tissue which is positioned near the distal ends of a pair of metatarsal bones within the foot. Among other athletes, long distance runners need to stretch the soft tissues of the various foot compartments in order to prevent stress fractures (most common in the metatarsals and calcaneus), as well as other overuse syndromes. These syndromes include plantar calcaneal enthesopathy, achillo-calcaneal enthesitis, renting at the tether zone of the Achilles tendon, as well as various degrees of posterior tibial syndrome. Heavy demand exists for treatment of such foot disorders.

One preferred mode of treatment involves rest and minimizing foot use. The problem with this mode of treatment is that the treatment time can be lengthy and inconvenient and the results less than satisfactory. A number of devices have been developed for the treatment of foot disorders which are used to stretch or massage the plantar fascia or other tissues of the foot, or to spread bones within the foot. The use of these devices provides less than the degree of successful treatment desired by the medical community.

An improved device for treating foot disorders and for stretching the soft tissues of the various foot compartments is needed. The device must be simple, have a low manufacturing cost and be easy to use. It should be capable of spreading a pair of metatarsal bones to treat Morton's neuroma. It should be capable of stretching the plantar fascia to treat plantar fasciitis. It should also be generally usable to stretch a variety of tissues within the foot.

The apparatus for treating foot disorders described herein addresses these needs.

### SUMMARY

An apparatus for treating foot disorders is comprised of a base, a stem and a therapeutic member. The base is configured to rest upon the floor. The stem extends from the upper side of the base. The therapeutic member is attached to the stem. It is attached to the end of the stem which is not attached to the base. The therapeutic member has a rigid flat upper surface distal to the base. The longest horizontal dimension of the upper surface is less than the width of an averaged sized human foot. This will allow a user/patient to rest a portion of the plantar surface of his or her foot on the therapeutic member. The base, the stem and the therapeutic member are configured such that a seated or a standing user may rest a portion of the plantar surface of one of the user's feet on the entire upper surface of the therapeutic member. The size, shape and weight of the base are selected to be sufficient to prevent movement of the base with respect to a floor upon which the base rests when a foot resting upon the therapeutic member slides across the upper surface of the therapeutic member.

In the preferred embodiment of the apparatus the therapeutic member has at its periphery a rigid, flat, smooth, slippery upper surface distal to the base. The upper surface should have a circular perimeter and a radiused edge at its perimeter. The upper surface should also have a central depression between it and the base to form a cavity within the upper surface, as shown in FIG. 6. The longitudinal axis of the stem and the horizontally planar surface of the base should be substantially perpendicular. Ideally, the therapeutic member is a removable from the stem so that therapeutic members with varying configurations may be attached to the stem. One such therapeutic member should have an upper surface diameter which is small enough to cause the spreading of two metatarsal bones of a user when that therapeutic member is pressed on the plantar side of a foot between two metatarsal bones of the user. Thus, the apparatus may be provided in kit form with a plurality of releasably removable therapeutic members.

### DRAWINGS

These and other features, aspects, and advantages of the present invention will become better understood with regard to the following description, appended claims, and accompanying drawings where:

FIG. 1 is a perspective view of a user using an apparatus for treating foot disorders.

FIG. 2 is a perspective view of the apparatus for treating foot disorders of FIG. 1.

FIG. 3 is a cut away sectional elevation view of the apparatus for treating foot disorders of FIG. 2.

FIG. 4 is an elevation view of the apparatus for treating foot disorders of FIG. 2.

FIG. 5 is an exploded perspective view of an alternate embodiment of an apparatus for treating foot disorders, comprising two therapeutic members which are releasably attachable to the stem by way of a detent mechanism.

FIG. 6 is a cut away sectional elevation view of the apparatus for treating foot disorders of FIG. 5, wherein the lower therapeutic member of FIG. 5 is attached to the stem of the apparatus by way of a detent mechanism.

FIG. 7 is a perspective view of the apparatus for treating foot disorders of FIG. 5, having a therapeutic member with a central depression attached to the stem.

FIG. 8 is a perspective view of the apparatus for treating foot disorders of FIG. 5, having a therapeutic member without a central depression attached to the stem.

FIG. 9 is a bottom plan view of the plantar surface of a foot being treated with an apparatus for treating foot disorders, wherein the therapeutic member of the apparatus is positioned between two metatarsal bones of the foot.

FIG. 10 is a bottom plan view of the plantar surface of a foot being treated with an apparatus for treating foot disorders, wherein the therapeutic member of the apparatus is positioned against the plantar fascia of the foot.

FIG. 11 is a perspective view of an improved apparatus for treating foot disorders.

FIG. 12 is a cut away sectional elevation view of the improved apparatus for treating foot disorders of FIG. 11.

FIG. 13 is an elevation view of the improved apparatus for treating foot disorders of FIG. 11.

FIG. 14 is an exploded perspective view of the improved apparatus for treating foot disorders of FIG. 11.

FIG. 15 is a bottom plan view of the plantar surface of a foot being treated with an improved apparatus for treating foot disorders, wherein the therapeutic member of the apparatus is positioned between two metatarsal bones of the foot.

FIG. 16 is a bottom plan view of the plantar surface of a foot being treated with an improved apparatus for treating foot disorders, wherein the therapeutic member of the apparatus is positioned against the plantar fascia of the foot.

FIG. 17 is a bottom plan view of the improved apparatus for treating foot disorders of FIG. 11.

FIG. 18 is a perspective view of a user using an improved apparatus for treating foot disorders.

### DESCRIPTION

An apparatus for treating foot disorders 20 is comprised of a base 22, a stem 24 and a therapeutic member 30.

The base 22 is sized and shaped to rest on a floor. Preferably, it is approximately 8 inches wide and 10 inches long. It may be fabricated from steel, plastic or other rigid materials. Alternatively, the base 22 may be configured so that when it rests upon the floor its upper surface is angled with respect to the floor, rather than being parallel to the floor. This, for example, would allow a user to sit in a chair 48, extend the user's leg, yet have the plantar surface 52 of the user's 46 foot 50 be substantially parallel to the upper surface of the base when the foot 50 is in its natural position.

The stem 24 is rigidly attached to the base 22. The stem 24 may be an independent part attached to the base 22 by welding, gluing, intermeshing threads, or otherwise. The stem 24 and the base 22 may be formed as one molded part. The stem 24 should perpendicularly extend from the base 22. The term perpendicularly extend also includes a stem 24 which substantially perpendicularly extends from the base 22. For example, the longitudinal axis of the stem 24 may extend at an angle, such as 60°, from the base 22, rather than extending at a 90° angle. The stem 24 may be fabricated from steel, plastic or other rigid materials. Preferably, the stem 24 has a length between ½″ and 2 inches.

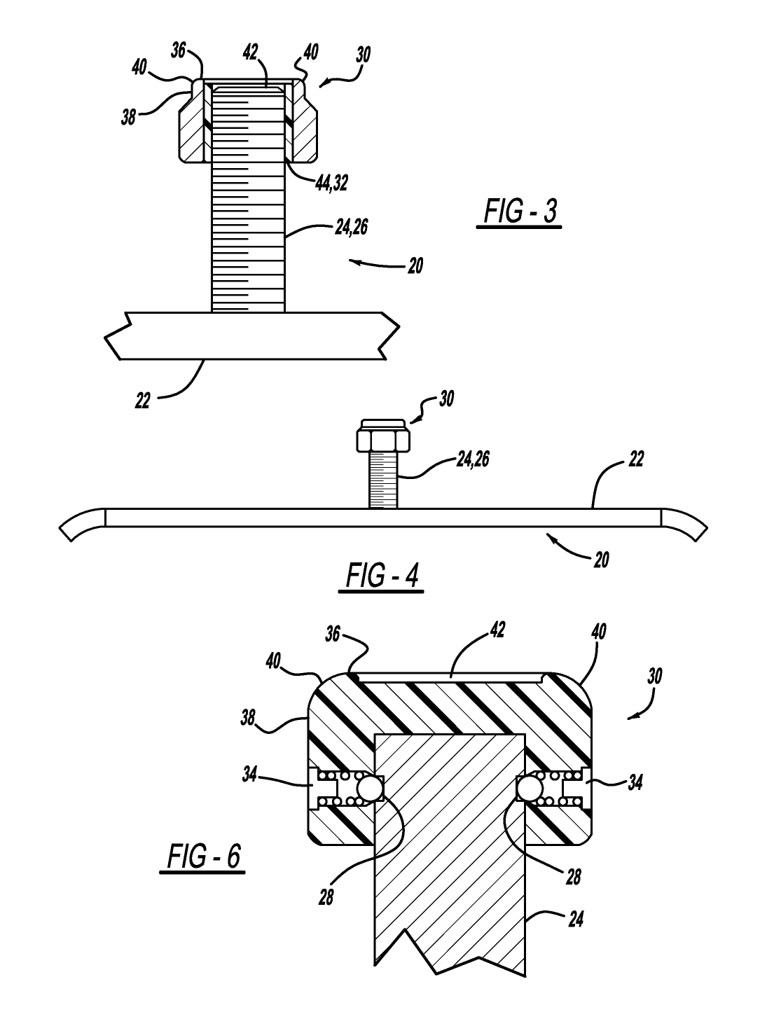

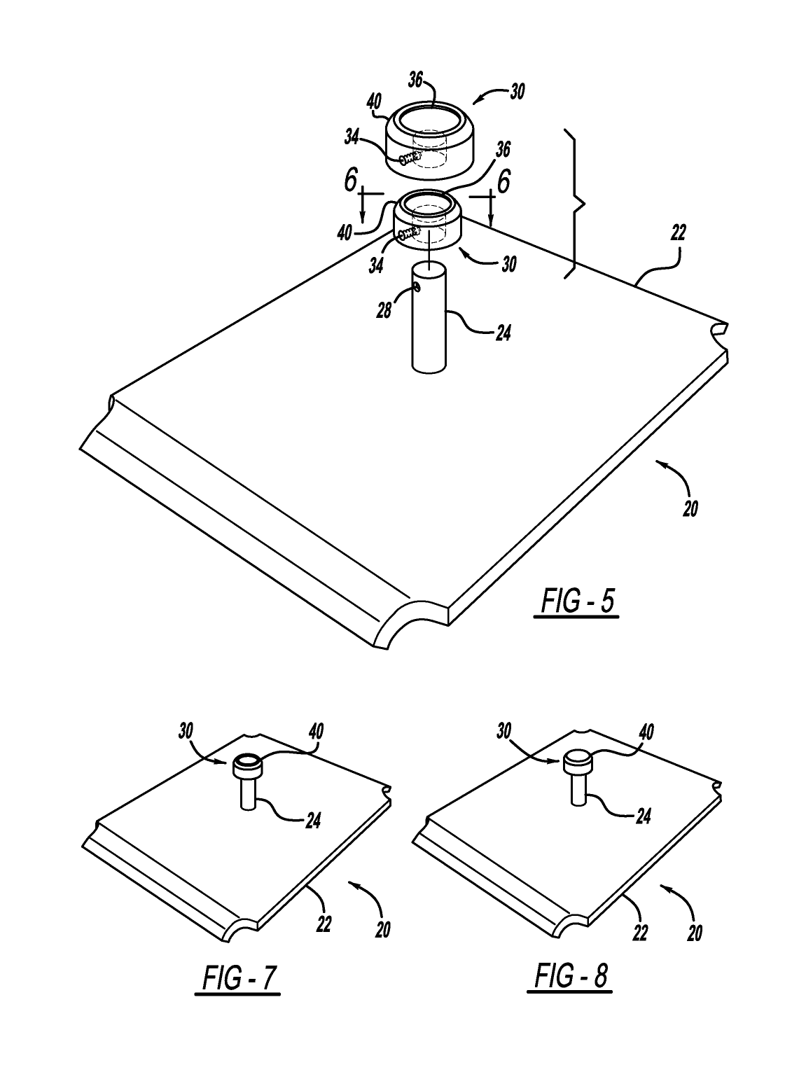

The therapeutic member 30 is an object which is attached to the stem 24 at the end of the stem 24 which is opposite to the base 22, as shown in FIG. 2 and FIG. 5. The upper surface 36 of the therapeutic member 30 is that surface which is distal to the base 22, as shown in FIG. 3. There, the upper surface 36 of the therapeutic member 30 is shown parallel to the base 22 and upwardly separated from the base 22. At its periphery the therapeutic member 30 has a rigid, flat, smooth, slippery upper surface 36. This upper surface 36 is distal to the base 22. The therapeutic member 30 may be fabricated from steel, plastic or other rigid materials. A rigid, flat, smooth, slippery upper surface 36 can be formed by precise molding or stamping of the part. These features of the upper surface 36 can also be enhanced by polishing the upper surface 36. Preferably, the upper surface 36 has a circular perimeter 38, as shown in FIGS. 2-6. The diameter of the circular perimeter 38 should be between ¼″ and 1 inch. The upper surface 36 should have a radiused edge 40, as shown in FIG. 3, FIG. 5 and FIG. 6. Other figures also show the radiused edge 40. The radiused edge 40 provides a smooth transition from a typically horizontally oriented upper surface 36 to a typically vertically oriented side of the therapeutic member 30. The term radiused edge 40 should also be understood to include edges which are beveled. In other words, a radiused edge 40 is an edge which provides a smooth transition from the upper surface 36 of the therapeutic member 30 to an orthogonally oriented side of the therapeutic member 30. The preferred radiused edge 40 is simply a traditional radiused edge, as shown in FIG. 6. The upper surface 36 should also have a central depression 42 within it. The central depression 42 should be formed as a concentric cavity within the upper surface 36. The depth of the central depression 42 can be less than 2 mm, while still providing therapeutic benefit. A typical central depression 42 is shown in FIG. 3 and FIG. 6. There, the central depression 42 is surrounded by the upper surface 36 of the therapeutic member 30. The diameter of the circular perimeter 38 of an upper surface 36 is less than the width of an average sized human foot. This will allow a user to rest the user's foot on top of the therapeutic member 30 and have the entire therapeutic member 30 covered by the user's foot. In one preferred embodiment of the apparatus 20, the diameter of the circular perimeter 38 is 11/16″, the annular width of the upper surface 36 is 1/16″ and the depth of the central depression 42 is 1/16″. The term annular width refers to the horizontal thickness of a ring shaped upper surface 36 on the upper aspect of the therapeutic member 30.

The therapeutic member 30 may be permanently attached to the stem 24. However, it is preferred that the therapeutic member 30 be removably attached to the stem 24. The therapeutic member 30 and the stem 24 may be formed with matching stem threads 26 and therapeutic member threads. For example, in FIG. 3 the therapeutic member 30 there is shown having a threaded bushing 44. The inside of the bushing 44 has threads which mate with the threads 32 of the therapeutic member 30. The outside of that bushing 44 is contiguous with a bore within the therapeutic member 30, as shown in FIG. 3. The therapeutic member 30 of FIG. 3 is adapted to be screwed onto the stem 24 of FIG. 3 such that the therapeutic member 30 is removably attached to the end of the stem 24.

FIG. 6 shows another method of removably attaching a therapeutic member 30 to a stem 24. The therapeutic member is provided with a detent mechanism 34. There, the detent mechanism 34 is comprised of two spring-loaded balls. The balls are shaped to locking only fit within corresponding detent cavities 28 formed into the stem 24. The therapeutic member 30 may be removably attached to the stem 24 by sliding the therapeutic member 30 onto the stem until each detent mechanism 34 locks into a detent cavity 28 on the stem 24. The therapeutic member 30 may be removed from the stem 24 by pulling it off with sufficient force to break the detent mechanism 34 connection.

The apparatus for treating foot disorders 20 may be comprised of a plurality of therapeutic members 30 to form a kit for treating foot disorders. The kit contains a plurality of therapeutic members 30. Each therapeutic member 30 is removably attachable to the stem 24 of the apparatus 20. Each therapeutic member 30 of the kit has an upper surface 36 with a different diameter. The diameter of the upper surface 36 of at least one therapeutic member 30 is small enough to cause the spreading of two metatarsal bones 54 of a user when that therapeutic member 30 is pressed on the plantar side 52 of the user's foot 50 between two metatarsal bones 54 of a user 46 being treated for a foot disorder. This will allow the apparatus 20 to be used to treat a foot disorder known as Morton's neuroma. In Morton's neuroma a nerve near the distal end of two metatarsal bones 54 becomes enlarged. This condition can be treated by spreading the two involved metatarsal bones 54 near their distal ends.

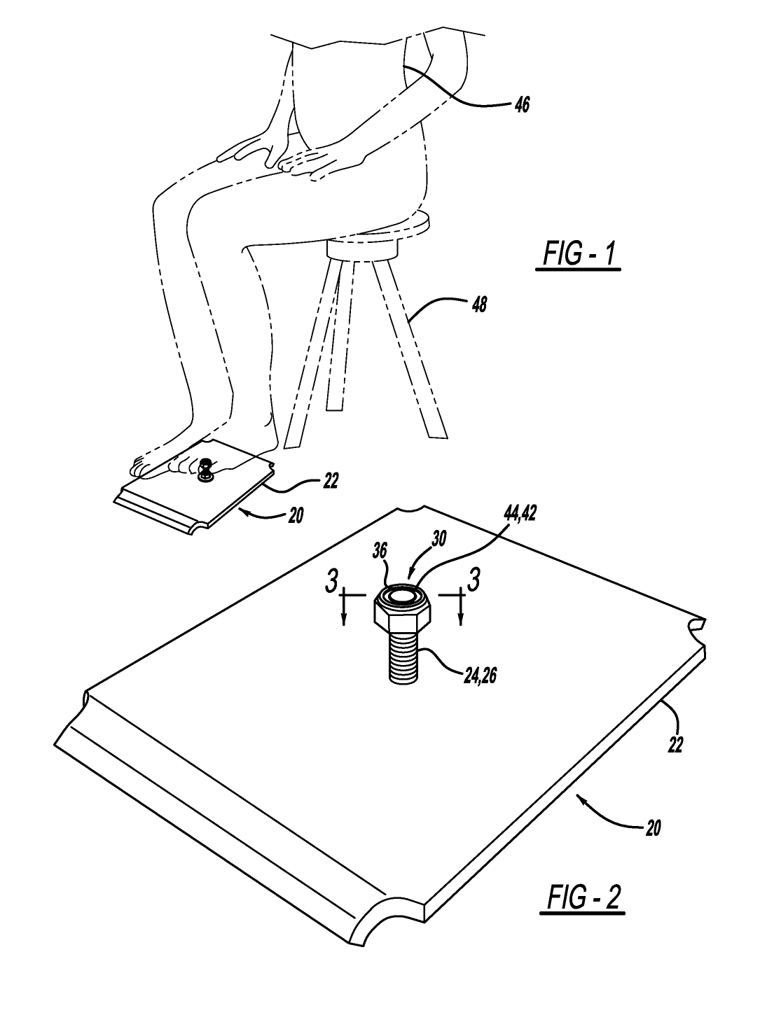

The dimensions of the base 22, the stem 24 and the therapeutic member 30 are such that a seated or standing user 46 may rest a portion of the plantar surface 52 of one of the user's feet 50 on the entire upper surface 36 of the therapeutic member 30. See FIG. 1. In other words, a user 46 can use the apparatus 20 while standing or while sitting. The size, shape and weight of the base 22 are configured to be sufficient to prevent movement of the base 22 with respect to a floor upon which it rests when a foot 50 resting upon the therapeutic member 30 slides across the upper surface 36 of the therapeutic member 30. As indicated above the preferred dimensions of the base 22 are 8″×10″. The preferred length of the stem is ½″ to 2 inches. The preferred diameter of the upper surface 36 of the therapeutic member 30 is ¼″ to 1 inch.

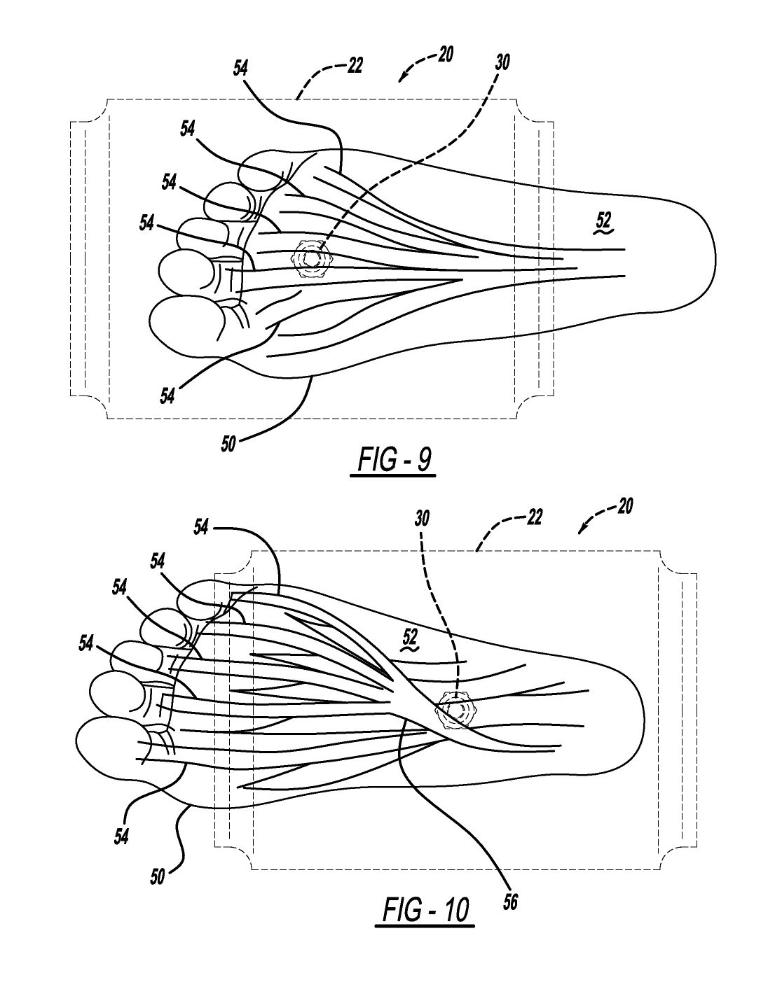

The apparatus for treating foot disorders 20 may be used to treat a variety of foot disorders which are responsive to stretching or a manipulation of the plantar surface of the foot 50. These disorders include plantar fasciitis, Morton's neuroma, heel spurs, tarsalgia and metatarsalgia. The user/patient 46 may stand or be seated in a chair 48 during treatment. If a chair 48 is used it is positioned with respect to the base 22 such that the user 46 may simultaneously sit on the chair 48, rest the user's foot 50 on the therapeutic member 30 and slide the user's foot 50 in all horizontally planar directions. First, an appropriately sized therapeutic member 30 must be selected and attached to the stem 24, or an apparatus 20 with a fixed appropriately sized therapeutic member 30 must be selected. For example, the diameter of the therapeutic member 30 to be used to treat Morton's neuroma should be small enough to spread the two metatarsal bones 54 surrounding the neuroma. The diameter of the therapeutic member 30 to be used to treat plantar fasciitis would be larger because the object is to stretch the plantar fascia, rather than to spread metatarsal bones 54. The plantar surface 52 of the foot 50 of the user/patient 46 is placed on top of the therapeutic member 30. Generally, the weight of the leg and foot cause sufficient pressure to be applied between the therapeutic member 30 and the plantar surface 52 of the foot 50. If desired, the amount of pressure may be metered by pressing down or lifting up on the foot 50. FIG. 9 shows the preferred initial position for treating Morton's neuroma. From this initial position between two metatarsal bones 54 the foot is moved forward and backward, as well as sideways if desired, to cause a spreading of the metatarsal bones 54 surrounding the neuroma. FIG. 10 shows the preferred initial position for treating plantar fasciitis. The therapeutic member 30 is positioned on the plantar surface 52 of the foot 50 such that the plantar fascia 56 may be stretched. Both FIG. 9 and FIG. 10 are views of the plantar surface 52 of a foot 50. The foot 50 is moved forward, backward and sideways, if desired, to cause the plantar fascia 56 to be stretched.

The apparatus 20 may be used by runners, before or after running, to stretch the plantar fascia 56 of their feet and the tissues within the arches of their feet. Runners should rake the apparatus 20 between their metatarsal bones 54. This will relieve muscle, tendon and ligament tension and help to prevent stress fractures.

The smooth and slippery features of the upper surface 36 of the therapeutic member 30, the circular perimeter 38 feature of the upper surface 36, the radiused edge 40 feature of the upper surface 36 and the central depression 42 of the therapeutic member 30 are not all necessary features of the apparatus for treating foot disorders 20. However, the combination of all of these features will provide maximum efficacy of the apparatus for treating foot disorders 20.

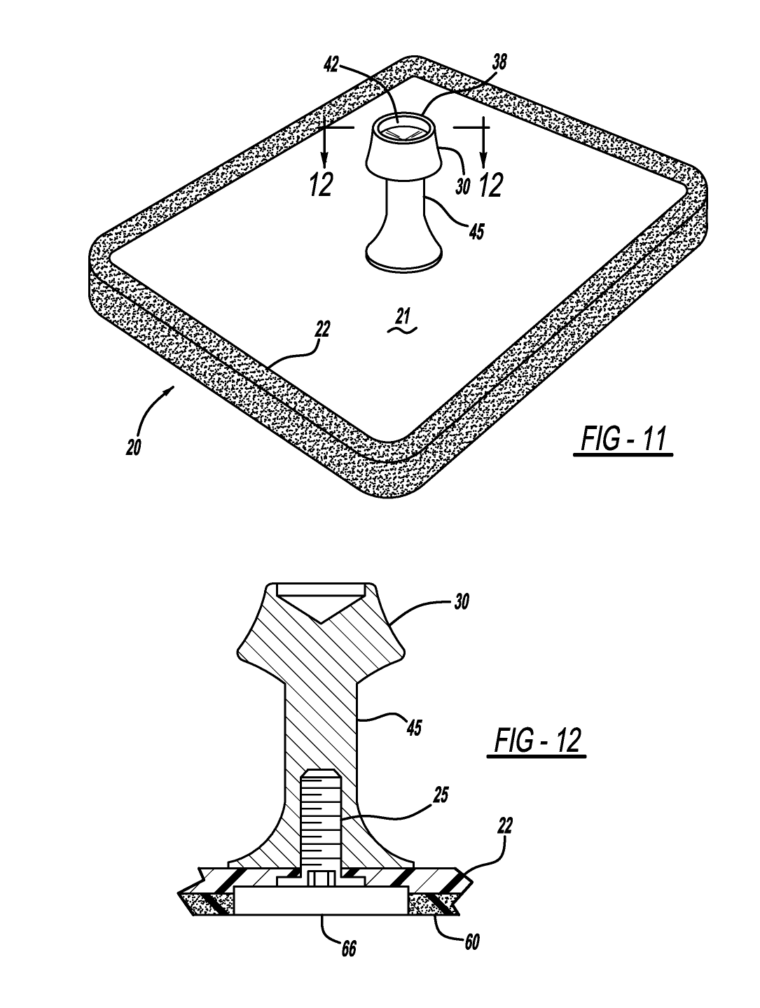

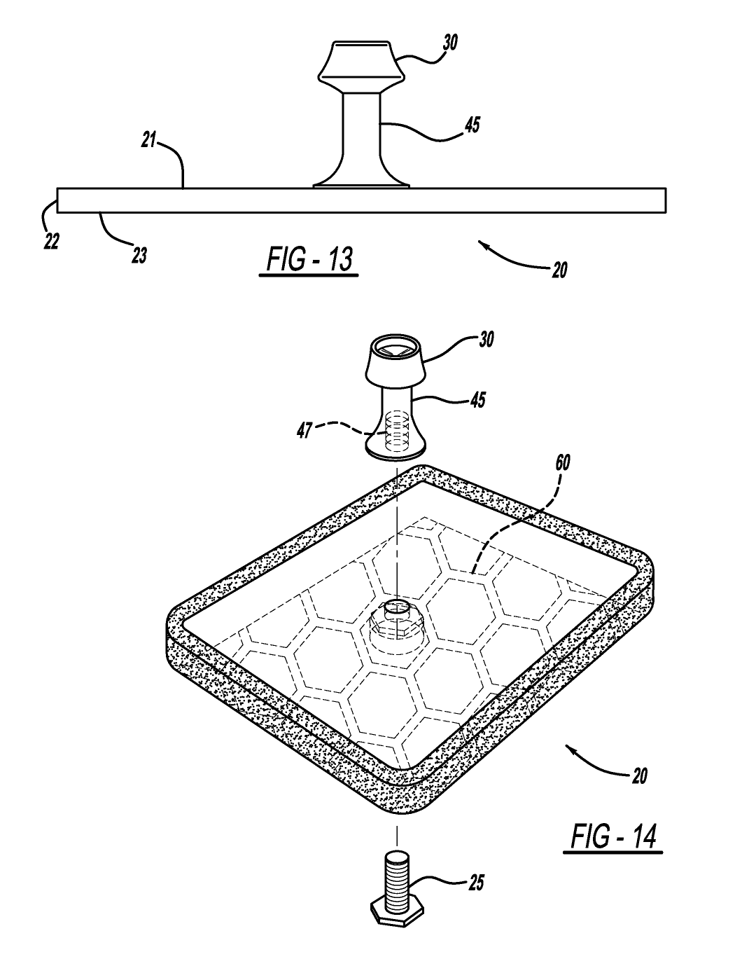

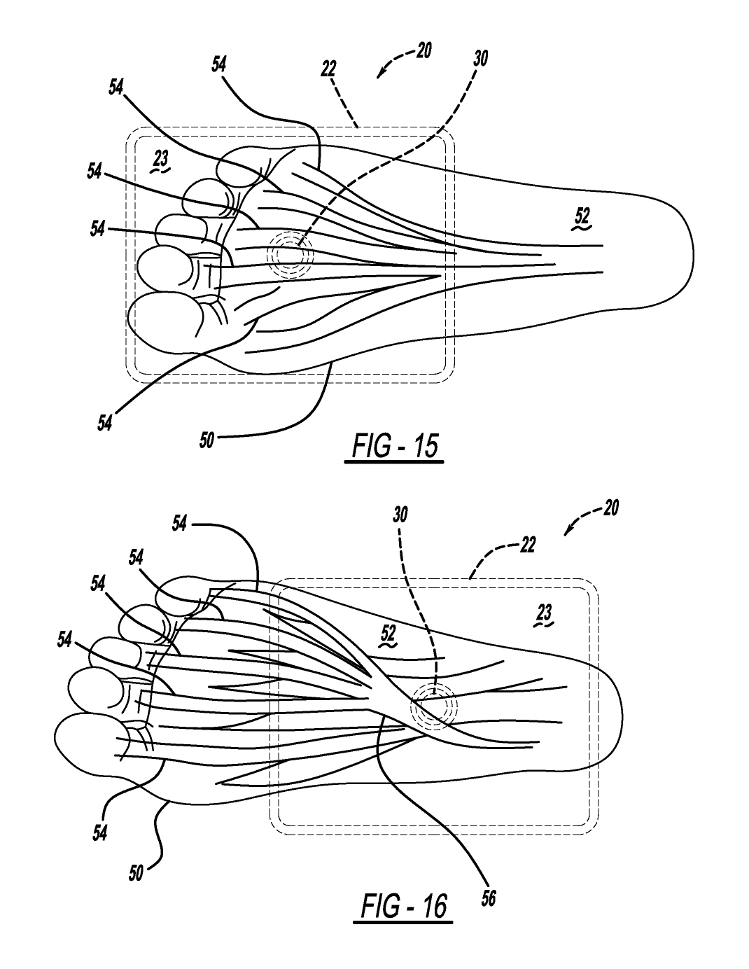

Additional refinements and modifications to the apparatus for treating foot disorders 20 heretofore described are provided in an improved apparatus for treating foot disorders 20. These refinements and modifications are shown within FIGS. 11-18. It should be understood that many of the features of the original apparatus for treating foot disorders 20 may be, and should be, incorporated into the improved apparatus for treating foot disorders 20.

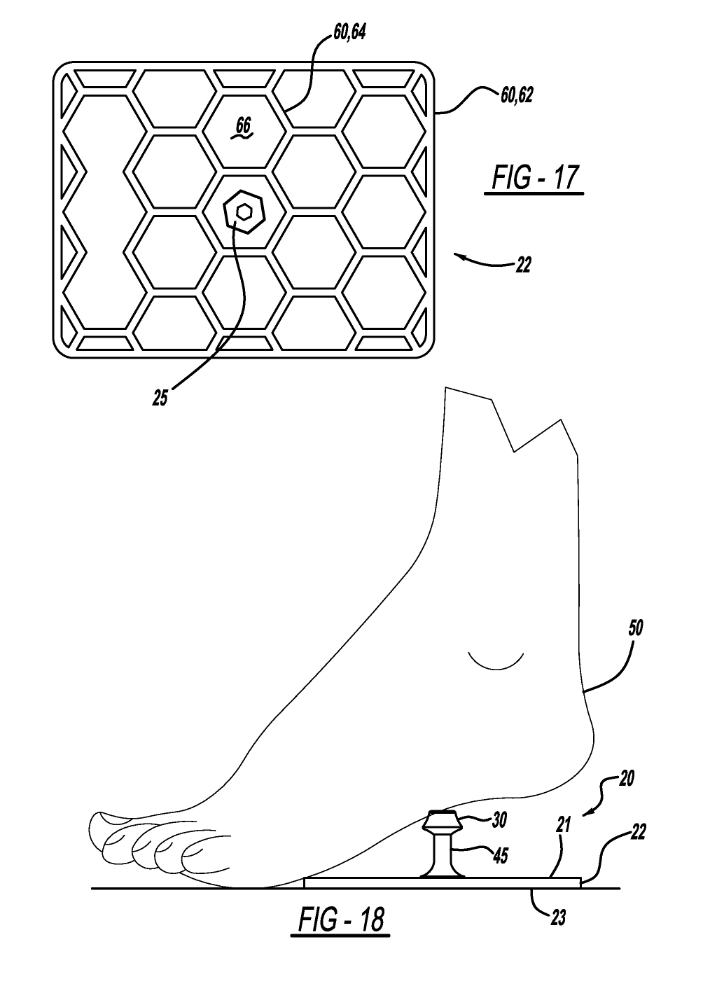

The base 22 of the improved apparatus for treating foot disorders 20 provides a better grip to the floor surface upon which it may be positioned. Therefore, the length and width of the base 22 of the improved apparatus for treating foot disorders 20 may be shorter compared to the original apparatus for treating foot disorders 20. The base 22 has an upper surface 21 and a lower surface 23. The upper surface 21 faces the user 46 during use. The lower surface 23 is on the other side of the base 22. Preferably, the base 22 is fabricated from rubber or plastic. In the preferred embodiment of the device a ridge network 60 perpendicularly extends from the lower surface 23 of the base 22. This is shown in FIGS. 12, 14 and 17. The ridges are simply wall like structures extending from the lower surface 23 of the base 22. The ridges provide enhanced adhesion between the base 22 and the floor upon which it is position, compared to a base having a flat lower surface. The ridges are formed into a ridge network 60. An example of a ridge network 60 perpendicularly extending from the lower surface of a base 22 is shown in FIG. 17. Note that the ridges are perpendicular to the lower surface 23 of the base 22. In FIG. 17, a portion of the ridge network 60 extends from the perimeter of the base 22 to form a perimeter ridge network 62. Another portion of the ridge network 60 shown in FIG. 17 extends from the lower surface 23 of the base 22 on the interior aspect of the perimeter of the base 22 to form an inner ridge network 64. Preferably, ridges of the inner ridge network 64 form closed paths such that one or more geometric structures 66 are formed. The geometric structures 66 have walls which are perpendicular to the bottom surface 23 of the base 22. FIG. 17 shows a plurality of hexagon shaped geometric structures 66. It also shows some geometric structures 66 which are essentially hexagons with one or more walls removed. For example, the left side of FIG. 17 shows a geometric structures 66 comprised of three stacked hexagons wherein one wall has been removed from each hexagon. Any of the hexagons shown in FIG. 17 can be considered to consist of six ridges forming a closed path. That closed path is the hexagon. That hexagon has walls which are perpendicularly oriented with respect to the lower surface 23 of the base 22.

In the preferred embodiment of the improved apparatus for treating disorders 20, the stem and the therapeutic member are one integral piece. Thus, the therapeutic member-stem combination 45 is one integral piece. The therapeutic member portion of the therapeutic member-stem combination 45 may have the features previously described. A plurality of therapeutic member-stem combinations 45, each having a different therapeutic member diameter and wherein the diameter of the upper surface of at least one therapeutic member is small enough to cause the spreading of metatarsal bones 54 of a user 46 when that therapeutic member is pressed on the plantar side 52 of a foot 50 between two metatarsal bones 54 of a user 46 being treated for a foot disorder, may be provided as a kit for treating foot disorders.

The improved apparatus for treating foot disorders 20 is often used with the user 46 seated on a chair 48. The chair 48 is positioned with respect to the base 22 such that the user 46 being treated for a foot disorder may simultaneously sit on the chair 48, rest of the user's 46 foot 50 on the therapeutic member of the therapeutic member-stem combination 45 and slide the user's 46 foot 50 in all horizontally planar directions. Preferably, the upper surface of the therapeutic member of the therapeutic member-stem combination 45 has a radiused edge 40 at its perimeter 38 and has a central depression 42 between the upper surface 36 of the therapeutic member and the base 22, as shown in FIGS. 11, 12 and 14.

In the preferred embodiment of the apparatus for treating foot disorders 20 the therapeutic member-stem combination 45 is removably attached to the base 22. This will allow for the therapeutic member-stem combination 45 to be quickly and easily attached and detached from the base 22. The therapeutic member-stem combination 45 must be attached to the base 22 for the device to be used. However, with the therapeutic member-stem combination 45 removed from the base 22, the device may be much more compactly stored or shipped.

FIGS. 11, 12, 14, and 17 show the preferred mode of removably attaching a therapeutic member-stem combination 45 to a base 22. A threaded bolt 25 is inserted through the bottom of the base 22 such that the threads of the bolt 25 are positioned above the upper surface 21 of the base 22 to engage with corresponding threads 47 within the therapeutic member-stem combination 45. The threaded bolt 25 shown has a hexagonal head. The shape and size of the hexagonal head is such that the hexagonally shaped geometric structure 66 extending from the lower surface 23 of the base 22 prevents the head from rotating, thus facilitating the tightening of the therapeutic member-stem combination 45 onto the threaded bolt 25. The therapeutic member-stem combination 45 may be easily installed onto the base 22 by screwing the therapeutic member-stem combination 45 onto the threads of the threaded bolt 25. The therapeutic member-stem combination 45 may be easily removed from the base 22 by unscrewing the therapeutic member-stem combination 45 from the threaded bolt 25.

The improved apparatus for treating foot disorders 20 is used to treat foot disorders in the same manner as previously described.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. An apparatus for treating foot disorders comprising:
(a) a base sized and shaped to rest on a floor, said base having an upper surface and a lower surface;
(b) a removable stem perpendicularly extending from the base;
(c) a therapeutic member integrally attached to the end of the stem opposite the base, said therapeutic member having at its periphery a rigid, flat, smooth, slippery upper surface distal to the base, said upper surface having a circular perimeter, said upper surface having a radiused edge at its perimeter, said upper surface having a central depression between it and the base to form a cavity within the upper surface, said upper surface having a diameter which is less than the width of an average sized human foot;
(d) wherein the dimensions of the base, the stem and the therapeutic member are such that a seated or a standing user may rest a portion of the plantar surface of one of the user's feet on the entire upper surface of the therapeutic member; and
(e) wherein the size, shape and weight of the base are sufficient to prevent movement of the base with respect to a floor upon which it rests when a foot resting upon the therapeutic member slides across the upper surface of the therapeutic member.

2. The apparatus for treating foot disorders of claim 1, further comprising a plurality of therapeutic member-stem combinations, each of said therapeutic member stem combinations being removably attachable to the base, each said therapeutic member stem combination having a therapeutic member with an upper surface with a different diameter and wherein the diameter of the upper surface of at least one therapeutic member is small enough to cause the spreading of two metatarsal bones of a user when that therapeutic member is pressed on the plantar side of a foot between two metatarsal bones of a user being treated for a foot disorder, thereby forming a kit for treating foot disorders.

3. The apparatus for treating foot disorders of claim 1, further comprising a chair, said chair being positioned with respect to the base such that a user being treated for a foot disorder may simultaneously sit on the chair, rest the user's foot on the therapeutic member and slide the user's foot in all horizontally planar directions.

4. An apparatus for treating foot disorders comprising:
(a) a base sized and shaped to rest on a floor said base having an upper surface and a lower surface;
(b) a removable stem perpendicularly extending from the base;
(c) a therapeutic member attached to the end of the stem opposite the base, said therapeutic member having a flat smooth upper surface distal to the base, said upper surface having a circular perimeter, said upper surface having a diameter which is less than the width of an average sized human foot;
(d) wherein the dimensions of the base, the stem and the therapeutic member are such that a seated or a standing user may rest a portion of the plantar surface of one of the user's feet on the entire upper surface of the therapeutic member; and
(e) wherein the size, shape and weight of the base are sufficient to prevent movement of the base with respect to a floor upon which it rests when a foot resting upon the therapeutic member slides across the upper surface of the therapeutic member.

5. The apparatus for treating foot disorders of claim 4, wherein the upper surface of the therapeutic member has a radiused edge at its perimeter and wherein the upper surface of the therapeutic member has a central depression between it and the base.

6. An apparatus for treating foot disorders comprising:
(a) a base having an upper surface and a lower surface;
(b) a removable stem extending from the upper surface of the base;
(c) a therapeutic member integrally attached to the stem, said therapeutic member having a rigid flat upper surface distal to the base, the longest dimension of said upper surface being less than the width of a foot being treated with the apparatus;
(d) wherein the dimensions of the base, the stem and the therapeutic member are such that a seated or a standing user may rest a portion of the plantar surface of one of the user's feet on the entire upper surface of the therapeutic member; and
(e) wherein the size, shape and weight of the base are sufficient to prevent movement of the base with respect to a floor upon which it rests when a foot resting upon the therapeutic member slides across the upper surface of the therapeutic member.

7. The apparatus for treating foot disorders of claim 6, further comprising a ridge network perpendicularly extending from the lower surface of the base.

8. The apparatus for treating foot disorders of claim 7, wherein the ridge network extends from the perimeter of the base.

9. The apparatus for treating foot disorders of claim 7, wherein the ridge network extends from the lower surface of the base inside of the perimeter.

10. The apparatus for treating foot disorders of claim 9, wherein the ridge network extending from the lower surface of the base inside of the perimeter comprises a plurality of ridges, wherein each said ridge forms a closed path such that a geometric structure oriented perpendicularly to the bottom surface of the base is formed.

11. The apparatus for treating foot disorders of claim 1, further comprising a ridge network perpendicularly extending from the lower surface of the base.

12. The apparatus for treating foot disorders of claim 11, wherein the ridge network extends from the perimeter of the base.

13. The apparatus for treating foot disorders of claim 11, wherein the ridge network extends from the lower surface of the base inside of the perimeter.

14. The apparatus for treating foot disorders of claim 13, wherein the ridge network extending from the lower surface of the base inside of the perimeter comprises a plurality of ridges, wherein each said ridge forms a closed path such that a geometric structure oriented perpendicularly to the bottom surface of the base is formed.

15. The apparatus for treating foot disorders of claim 4, further comprising a ridge network perpendicularly extending from the lower surface of the base.

16. The apparatus for treating foot disorders of claim 15, wherein the ridge network extends from the perimeter of the base.

17. The apparatus for treating foot disorders of claim 15, wherein the ridge network extends from the lower surface of the base inside of the perimeter.

18. The apparatus for treating foot disorders of claim 17, wherein the ridge network extending from the lower surface of the base inside of the perimeter comprises a plurality of ridges, wherein each said ridge forms a closed path such that a geometric structure oriented perpendicularly to the bottom surface of the base is formed.
